(19) United States
(12) Patent Application Publication
(10) Pub. No.: US 2004/0184184 A1
(43) Pub. Date: Sep. 23, 2004

(54) Disk drive having flexible circuit board connecting between main frame and main printed circuit board

(75) Inventors: Hisateru Komatsu, Tendo-shi (JP); Noriyuki Kobayashi, Tendo-shi (JP); Makoto Konno, Tendo-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Mitsumi Electric Co., Ltd., Tokyo (JP)

(21) Appl. No.: 10/767,890

(22) Filed: Jan. 28, 2004

(30) Foreign Application Priority Data
Jan. 29, 2003 (JP) 20292/2003

(51) Int. Cl. G11B 17/00

(52) U.S. Cl. 360/97.01

(57) ABSTRACT

In the state where a terminal forming portion of a flexible circuit board is inserted through a first insertion hole formed in a main frame and a second insertion hole formed in a main printed circuit board, the terminal forming portion is bent so as to confront a back surface of the main printed circuit board. A terminal portion of the terminal forming portion is connected, by soldering, to a circuit pattern formed on the back surface of the main printed circuit board.

This application claims priority to prior Japanese application JP 2003-20292, the disclosure of which is incorporated herein by reference.

### Background of the Invention

The present invention relates to a disk drive and, in particular, relates to a disk drive having a structure wherein a printed circuit board is placed on a principal surface of a motor frame.

As described in, for example, JP-A-2000-232283, a conventional disk drive has a connection structure wherein a recording head and a printed circuit board are connected to each other by the use of a flexible circuit board for carrying out signal exchange therebetween.

In the disk drive, one end of an FPC, serving as the flexible circuit board, is connected to the recording head. A terminal forming portion, on the side of the other end, of the FPC is attached to an FPC holder and inserted through a mounting hole of the printed circuit board. Further, before the insertion into the mounting hole of the printed circuit board, the FPC holder attached with the terminal forming portion of the FPC is inserted through a guide hole formed in a chassis. The guide hole of the chassis is formed with a support projection on an inner surface thereof. The support projection supports the FPC holder.

The terminal forming portion has terminal portions exposed at the other end of the FPC. The terminal portions are electrically connected to circuit patterns formed on the printed circuit board.

In the conventional disk drive, however, the terminal forming portion of the FPC is attached to the FPC holder, and the FPC holder with the FPC is inserted through the guide hole of the chassis and supported by the chassis. Therefore, there has been a problem that inasmuch as it is necessary to provide the FPC holder, the guide hole corresponding to the FPC holder, and the support projection therefor, the number of the parts of the disk drive is increased to complicate the assembly operation thereof.

### SUMMARY OF THE INVENTION

It is therefore an object of the present invention to provide a disk drive that can reduce the number of parts thereof and thus facilitate an assembly operation thereof.

According to the present invention, there is provided a disk drive comprising a carriage assembly (15) retaining a magnetic head (14) for carrying out reading/writing of data with respect to a magnetic recording medium of a disk, a main frame (13) having a principal surface provided thereon with the carriage assembly (15), a main printed circuit board (30) provided at a back surface of the main frame (13), and a flexible circuit board (152) connecting between the main frame (13) and the main printed circuit board (30), wherein the flexible circuit board (152) has a one-end side connected to the carriage assembly (15) and comprises a terminal forming portion (152a) formed on an other-end side extending from the one-end side, and a terminal portion (152b) located on a tip side of the terminal forming portion (152a), the main frame (13) has a first insertion hole (13a) for inserting the terminal forming portion (152a) therethrough, the main printed circuit board (30) has a second insertion hole (30a) for inserting the terminal forming portion (152a) therethrough, the terminal forming portion (152a) is bent so as to confront a back surface of the main printed circuit board (30) in the state where the terminal forming portion (1 52a) is inserted through the first and second insertion holes (13a, 30a), and the terminal portion (152b) is connected to a circuit pattern (30b) provided on the back surface of the main printed circuit board (30).

It may be configured that the first insertion hole (13a) is an elongate hole, at least one side of the first insertion hole (13a) in a width direction perpendicular to a longitudinal direction thereof is formed with a plurality of projections (13b) protruding toward the other side confronting the one side, and movement of the terminal forming portion (152a) in the first insertion hole (13a) is inhibited in the width direction between the other side confronting the one side and the projections (13b).

The second insertion hole (30a) may have a width dimension greater than a width dimension of the first insertion hole (13a) in the width direction.

The terminal portion (152b) and the circuit pattern (30b) may be connected to each other by soldering using solder (390).

It is readily understood that the foregoing reference symbols in parentheses are given only for facilitating understanding of the present invention and are not intended to limit the present invention in any aspect.

### BRIEF DESCRIPTION OF THE DRAWING

FIG. 1 is a perspective view of a disk drive according to a preferred embodiment of the present invention;

FIG. 2 is an exploded perspective view of the disk drive illustrated in FIG. 1;

FIG. 3 is an enlarged sectional view partly showing a main frame and a main printed circuit board connected with a flexible circuit board in the disk drive illustrated in FIGS. 1 and 2; and

FIG. 4 is a perspective view of the main frame and the flexible circuit board illustrated in FIG. 3.

### Description of the Preferred Embodiment

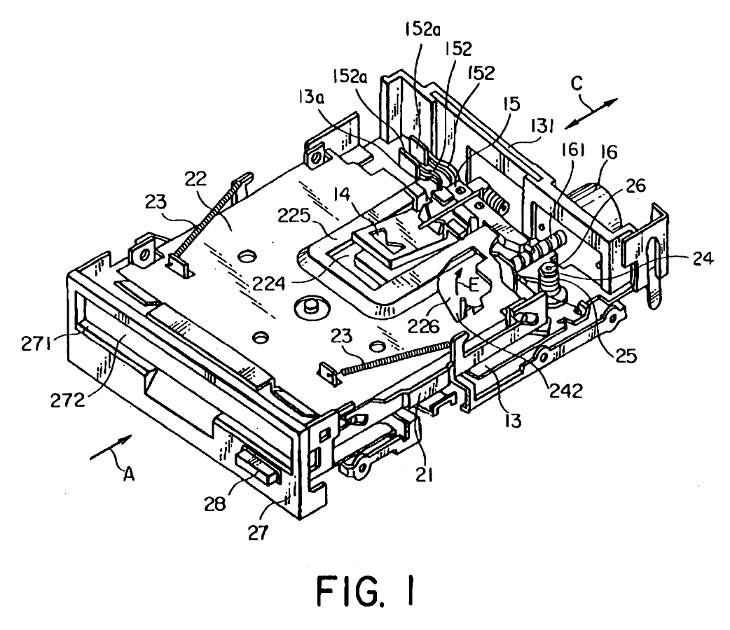

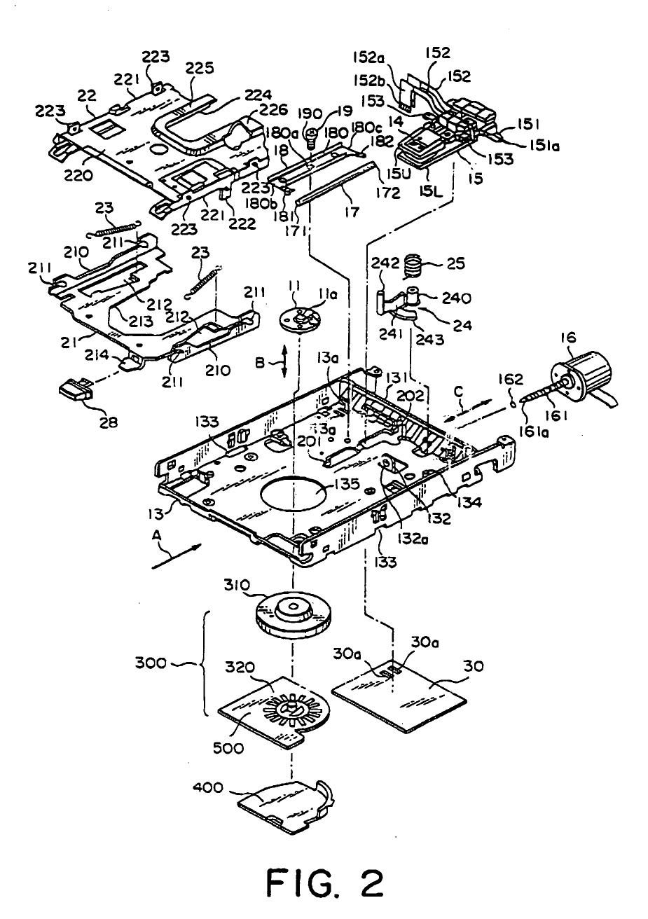

Referring to FIGS. 1 to 4, description will be given hereinbelow about a preferred embodiment of a disk drive according to the present invention. FIG. 1 shows the disk drive in an assembled state, while FIG. 2 shows the disk drive in a disassembled state.

The shown disk drive is an apparatus for driving a disk such as a 3.5-inch flexible disk (not shown).

Referring to FIGS. 1 and 2, the disk is inserted into the disk drive in an insert direction identified by an arrow A in FIGS. 1 and 2. The disk thus inserted is retained on a disk table 11 with a center axis of the disk coinciding with a rotation shaft 11a of the disk table 11.

The disk table 11 is rotatably supported on a principal surface of a main frame 13. Therefore, an axial direction B of the rotation shaft 11a of the disk table 11 is parallel to a thickness direction of the main frame 13 The disk table 11 is rotated by a spindle motor (also called a DD motor) 300 mounted on a back surface, opposite to the principal surface, of the main frame 13 so that a magnetic recording medium of the disk retained on the disk table 11 is rotated. A main printed circuit board 30 with a number of electronic components mounted thereon is attached to the back surface of the main frame 13.

The disk drive further comprises a pair of upper and lower magnetic heads 14 (only the upper one being shown) for reading/writing data from/into the magnetic recording medium of the disk.

The magnetic heads 14 are supported by a carriage assembly 15 at its forward end, which is mounted on a rear side of the disk drive. Specifically, the carriage assembly 15 comprises an upper carriage 15U supporting the upper magnetic head 14, and a lower carriage 15L supporting the lower magnetic head 14. The carriage assembly 15 is disposed with a given space kept from the principal surface of the main frame 13, and supports the magnetic heads 14 at its forward end so that the magnetic heads 14 are movable with respect to the disk in a predetermined radial direction identified by an arrow C in FIGS. 1 and 2.

A stepping motor 16 is fixed to a rear side wall 131 of the main frame 13. The stepping motor 16 linearly drives the carriage assembly 15 in the predetermined radial direction C. Specifically, the stepping motor 16 has a rotation shaft (driving shaft) 161 extending in parallel to the predetermined radial direction C. The rotation shaft 161 is male-threaded to have a male screw thereon. A tip 161a of the rotation shaft 161 penetrates a hole 132a formed in a bent portion 132 that is erected from the principal surface of the main frame 13 by cutting and raising a portion of the main frame 13. A steel ball 162 is provided in the hole 132a. By the use of the hole 132a and the steel ball 162, the rotation shaft 161 is forced to extend in parallel to the predetermined radial direction C with its tip 161a being rotatably retained.

On the other hand, the carriage assembly 15 comprises an arm 151 extending from the lower carriage 15L to the rotation shaft 161. A tip 151a of the arm 151 is engaged with a root of the male screw of the rotation shaft 161 Therefore, when the rotation shaft 161 of the stepping motor 16 is rotated, the tip 151a of the arm 151 is moved along the root of the male screw of the rotation shaft 161 so that the carriage assembly 15 itself is moved in the predetermined radial direction C. Consequently, the stepping motor 16 serves as driving means for linearly moving the carriage assembly 15 in the predetermined radial direction C.

The rotation shaft 161 of the stepping motor 16 is provided on one side of the carriage assembly 15. Therefore, the one side of the carriage assembly 15 is movably supported by the rotation shaft 161 with the given space kept from the principal surface of the main frame 13.

However, only with the support by the rotation shaft 161, it is not possible to dispose the whole of the carriage assembly 15 so as to be spaced apart from the principal surface of the main frame 13. To this end, a guide bar 17 is used to support and guide the carriage assembly 15 on the other side thereof. Accordingly, as appreciated, the guide bar 17 and the rotation shaft 161 of the stepping motor 16 are provided on the opposite sides with respect to the carriage assembly 15. The guide bar 17 extends in parallel to the predetermined radial direction C and has one end 171 and the other end 172 fixed to the principal surface of the main frame 13, to thereby guide the carriage assembly 15 in the predetermined radial direction C. With this arrangement, the whole of the carriage assembly 15 is disposed so as to be spaced apart from the principal surface of the main frame 13.

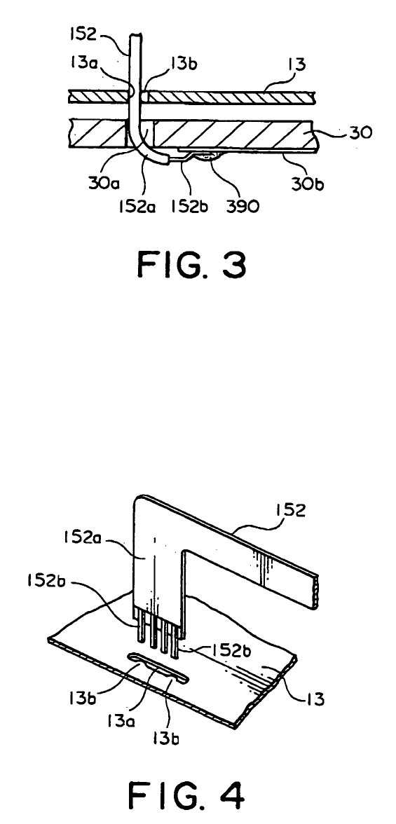

The disk drive further comprises a pair of flexible printed circuits (hereinafter referred to as “FPCs”) 152 each serving as a flexible circuit board. Each FPC 152 has one end connected to the carriage assembly 15, extends from the carriage assembly 15 on the side of the guide bar 17, and has the other end electrically connected to the main printed circuit board 30 attached to the back surface of the main frame 13, as also shown in FIGS. 3 and 4. A connection structure that connects between the main frame 13 and each FPC 152 will be described later in detail.

The guide bar 17 is clamped on the principal surface of the main frame 13 by the use of a guide bar clamp 18. The guide bar clamp 18 is fixed at its center to the principal surface of the main frame 13 by the use of a binding screw 19. Specifically, the guide bar clamp 18 comprises a rectangular fixing member 180 having a length slightly greater than that of the guide bar 17. The rectangular fixing member 180 is formed at its center with a hole 180a having a size to allow a screw shaft 190 of the binding screw 19 to pass therethrough. A pair of arms 181 and 182 extend from one end 180b and the other end 180c of the rectangular fixing member 180 so as to clamp the one end 171 and the other end 172 of the guide bar 17, respectively.

Since the guide bar clamp 18 merely clamps the guide bar 17, it is not possible to fix the guide bar 17 relative to the principal surface of the main frame 13 by the use of only the guide bar clamp 18. Consequently, a pair of positioning members for fixing positions of both ends 171 and 172 of the guide bar 17 are required. Such positioning members are achieved by a pair of bent portions 201 and 202 each formed by cutting and raising a portion of the main frame 13 so as to be erected from the principal surface of the main frame 13.

The lower carriage 15L of the carriage assembly 15 also serves as a support frame supporting the carriage assembly 15 so as to be slidable along the guide bar 17. The lower carriage 15L has a projecting portion (not shown) protruding toward the guide bar 17, and the guide bar 17 is slidably fitted in the projecting portion.

The disk drive further comprises an eject plate 21 and a disk holder 22. Each of the main frame 13, the eject plate 21, and the disk holder 22 is formed by applying punching, pressing, and bending processes to a metal plate.

The eject plate 21 is mounted on the main frame 13 so as to be slidable in the insert direction A of the disk and an eject direction opposite thereto. As will be described later, the eject plate 21 holds the disk cooperatively with the disk holder 22 when the disk drive is operated.

For allowing the disk to be inserted into the disk drive in the insert direction A and to be ejected from the disk drive in the eject direction, the eject plate 21 holds the disk so as to be slidable in the insert direction A and the eject direction.

The eject plate 21 comprises a pair of side walls 210 confronting each other. Each of the side walls 210 is formed with a pair of cam portions 211. A bottom wall of the eject plate 21 is provided with a pair of cut portions 212 formed along the side walls 210, respectively, and a generally U-shaped cutout portion 213 formed at its center portion to surround the disk table 11. Further, the bottom wall has a lower surface provided with a pin (not shown). The pin is adapted to be engaged with a locking portion 243 of an eject lever 24 which will be described later.

The disk holder 22 is disposed on the eject plate 21. The disk holder 22 comprises a principal surface 220 and a pair of side walls 221 formed on both sides of the principal surface 220 so as to confront each other. The side walls 221 are formed with projections 222 (only one of them being shown), respectively. The projections 222 are inserted into holes 133 of the main frame 13 through the cut portions 212 of the eject plate 21, respectively. By the insertion of the projections 222 into the holes 133 of the main frame 13, the disk holder 22 is positioned with respect to the main frame 13 in the insert direction A. Simultaneously,.the disk holder 22 is allowed to reciprocate in the axial direction B of the rotation shaft 1a of the disk table 11. Further, each of the side walls 221 is provided with a pair of pins 223. The pins 223 are inserted in the cam portions 211 formed in each of the side walls 210 of the eject plate 21, respectively. A pair of eject springs 23 are bridged between the disk holder 22 and the eject plate 21.

The disk holder 22 is provided with a generally rectangular opening 224 at its center portion inward in the insert direction A. Specifically, the opening 224 is located at a position corresponding to the upper carriage 15U of the carriage assembly 15 and extends in the predetermined radial direction C. The opening 224 is surrounded by a generally U-shaped raised edge 225 that is raised from the principal surface 220 of the disk holder 22 along the periphery of the opening 224.

On the other hand, the carriage assembly 15 has a pair of lateral arms 153 extending laterally and located over the raised edge 225. As will be described later, in the state where th disk is ejected from the disk holder 22, the lateral arms 153 are engaged with the raised edge 225 to thereby separate the upper and lower magnetic heads 14 from each other. Further, the disk holder 22 has an opening 226 located inward in the insert direction A on a right side of the opening 224 and having such a shape that allows rotation of an arm portion (lever portion) 241 of the eject lever 24.

On the main frame 13, the eject lever 24 is rotatably mounted in the neighborhood of the carriage assembly 15. Specifically, the main frame 13 is provided with a rod pin 134 erected and extending upward from the principal surface thereof. The eject lever 24 comprises a tubular portion 240 into which the rod pin 134 is fitted, the arm portion 241 extending from the tubular portion 240 in a radial direction, a projecting portion 242 provided at a free end of the arm portion 241 and extending upward, and the arc-shaped locking portion 243 extending from a free-end side of the arm portion 241 in a circumferential direction.

The eject lever 24 is provided with an eject lever spring 25 mounted around the tubular portion 240. The eject lever spring 25 urges the eject lever 24 in a counterclockwise direction (opposite to a direction identified by an arrow E) in the figure. The projecting portion 242 of the eject lever 24 is loosely received in the opening 226 of the disk holder 22. The projecting portion 242 is engaged with a shutter of the disk at a predetermined position to control opening and closing of the shutter.

As shown in FIG. 1, a screw 26 is threaded into the tip of the rod pin 134 to thereby prevent the eject lever 24 from coming off the rod pin 134.

A front panel 27 is attached to a front end portion of the main frame 13. The front panel 27 has an opening 271 for insertion and ejection of the disk, and a door 272 for closing the opening 271. The front panel 27 is provided with an eject button 28 protruding therefrom so as to be movable backward and forward. The eject button 28 is fitted over a projecting portion 214 protruding forward from a front end of the eject plate 21.

Next, the spindle motor 300 used in the disk drive will be described.

The shown spindle motor 300 comprises a rotor 310 and a stator 320 combined with the rotor 310. The disk table 11 is fixedly attached to an upper surface of the rotor 310. The main frame 13 is provided with a circular opening 135 that allows only an upper part of the rotor 310 to protrude upward from the principal surface thereof. Consequently, the disk table 11 protrudes above the principal surface of the main frame 13.

The disk table 11 has the rotation shaft 11a made of metal and integrally fixed thereto. The stator 320 is attached to the back surface of the main frame 13 by the use of a motor frame 400 made of metal. Specifically, the stator 320 is mounted on a printed circuit board 500 and, after the printed circuit board 500 with the stator 320 mounted thereon is fixed on a principal surface of the motor frame 400, the motor frame 400 is fixedly attached to the main frame 13.

Referring now to FIGS. 3 and 4, detailed description will be given about the connection structure wherein each FPC 152 connects between the main frame 13 and the main printed circuit board 30.

Each FPC 152 comprises two insulating films and a plurality of conductors arranged in parallel between the two films. Each FPC 152 has a tip portion on the other-end side thereof where the two films are exfoliated. Each FPC 152 comprises a terminal forming portion 152a formed on the other-end side thereof, and terminal portions 152b located on a tip side of the terminal forming portion 152a. The main frame 13 is formed with a pair of first insertion holes 13a for inserting the terminal forming portions 152a of the FPCs 152, respectively, while the main printed circuit board 30 is formed with a pair of second insertion holes 30a for inserting the terminal forming portions 152a of the FPCs 152, respectively.

As shown in FIG. 3, in the state where the terminal forming portion 152a is inserted through the first insertion hole 13a and the second insertion hole 30a, an end portion of the terminal forming portion 152a is bent so as to confront a back surface of the main printed circuit board 30. Herein, the back surface of the main printed circuit board 30 is opposite to a surface of the board 30 confronting the back surface of the main frame 13. Each of the terminal portions 152b is electrically connected, by solder 390, to a circuit pattern 30b formed on the back surface of the main printed circuit board 30.

Each of the first insertion holes 13a is an elongate hole. At least one side of the first insertion hole 13a in a width direction perpendicular to a longitudinal direction thereof is formed with a plurality of projections 13b protruding toward the other side confronting such one side.

Movement of the terminal forming portion 152a in the first insertion hole 13a is inhibited in the width direction between the other side and the projections 13b, and further inhibited in the longitudinal direction of the hole 13a. The second insertion hole 30a may have a width dimension greater than a width dimension of the first insertion hole 13a in the width direction thereof.

As described above, according to the foregoing embodiment, the terminal forming portion 152a of the FPC 152 is bent so as to confront the back surface of the main printed circuit board 30 in the state where the terminal forming portion 152a is inserted through the first insertion hole 13a formed in the main frame 13 and the second insertion hole 30a formed in the main printed circuit board 30. Further, each terminal portion 152b is directly connected to the circuit pattern 30b formed on the back surface of the main printed circuit board 30. Therefore, the number of the parts of the disk drive can be reduced so that it is possible to provide the disk drive which can facilitate the assembly operation thereof.

What is claimed is:

1. A disk drive comprising a carriage assembly retaining a magnetic head for carrying out reading/writing of data with respect to a magnetic recording medium of a disk, a main frame having a principal surface provided thereon with said carriage assembly, a main printed circuit board provided at a back surface of said main frame, and a flexible circuit board connecting between said main frame and said main printed circuit board,
wherein
said flexible circuit board has a one-end side connected to said carriage assembly and comprises a terminal forming portion formed on an other-end side extending from said one-end side, and a terminal portion located on a tip side of said terminal forming portion,
said main frame has a first insertion hole for inserting said terminal forming portion therethrough,
said main printed circuit board has a second insertion hole for inserting said terminal forming portion therethrough,
said terminal forming portion is bent so as to confront a back surface of said main printed circuit board in the state where said terminal forming portion is inserted through said first and second insertion holes, and
said terminal portion is connected to a circuit pattern provided on the back surface of said main printed circuit board.

2. The disk drive according to claim 1, wherein said first insertion hole is an elongate hole, at least one side of said first insertion hole in a width direction perpendicular to a longitudinal direction thereof is formed with a plurality of projections protruding toward the other side confronting said one side, and movement of said terminal forming portion in said first insertion hole is inhibited in said width direction between said other side confronting said one side and said projections.

3. The disk drive according to claim 1, wherein said second insertion hole has a width dimension greater than a width dimension of said first insertion hole in said width direction.

4. The disk drive according to claim 1, wherein said terminal portion and said circuit pattern are connected to each other by soldering.
